(19) United States
(12) Patent Application Publication
(10) Pub. No.: US 2016/0378589 A1
(43) Pub. Date: Dec. 29, 2016

(54) COMPUTER-READABLE RECORDING MEDIUM, INFORMATION PROCESSING APPARATUS, AND CONTROL METHOD

(71) Applicant: FUJITSU LIMITED, Kawasaki-shi (JP)

(72) Inventor: Ayaka Kambayashi, Kawasaki (JP)

(73) Assignee: FUJITSU LIMITED

(21) Appl. No.: 15/192,158

(22) Filed: Jun. 24, 2016

(30) Foreign Application Priority Data
Jun. 25, 2015 (JP) 2015-127525

(51) Int. Cl. G06F 11/10; G06F 3/06

(52) U.S. Cl. CPC G06F 11/1004; G06F 3/0619; G06F 3/064; G06F 3/0673

(57) ABSTRACT

According to an aspect of the embodiments, an information processing apparatus includes a target storage device, and a processor configured to acquire an access load to the target storage device, to determine, based on the access load and a monitoring load with respect to the target storage device, whether the target storage device is error-checked or not and to error-check the target storage device when determining that the target storage device is error-checked.

### CROSS-REFERENCE TO RELATED APPLICATION

This application is based upon and claims the benefit of priority of the prior Japanese Patent Application No. 2015-127525, filed on Jun. 25, 2015, the entire contents of which are incorporated herein by reference.

### FIELD

The embodiments discussed herein are related to a computer-readable recording medium, an information processing apparatus, and a control method.

### BACKGROUND

A checksum function is known as a technology for monitoring a disk (which will also be referred to as a storage device). The checksum function is a function for detecting data corruption when reading data. When reading the data, an accessed disk area is error-checked by, e.g., the checksum function as to whether the disk area contains the data corruption. In this case, the accessed disk area is error-checked.
[Patent document 1] Japanese Laid-Open Patent Publication No. 2008-3940
[Patent document 2] Japanese Laid-Open Patent Publication No. 2010-191594

### SUMMARY

According to an aspect of the embodiments, an information processing apparatus includes a target storage device, and a processor configured to acquire an access load to the target storage device, to determine, based on the access load and a monitoring load with respect to the target storage device, whether the target storage device is error-checked or not and to error-check the target storage device when determining that the target storage device is error-checked.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of how a disk is monitored based on a checksum function;

FIG. 2 is a diagram illustrating an example of monitoring the whole disk by installing empty files;

FIG. 3 is a diagram illustrating an example of a variation of an I/O load;

FIG. 4 is a diagram illustrating examples of the I/O load and a variation of the load caused by monitoring;

FIG. 5 is a diagram depicting one example of a hardware configuration of an information processing apparatus;

FIG. 6 is a diagram illustrating one example of a functional configuration of the information processing apparatus;

FIG. 7 is a diagram illustrating an example of a monitoring target disk;

FIG. 8 is a diagram illustrating one example of a data structure of a monitoring priority level table;

FIG. 9 is a diagram illustrating one example of a data structure of a data priority level table;

FIG. 10 is a diagram illustrating one example of a data structure of an access history table;

FIG. 11 is a flowchart of a specific example of a monitor process;

FIG. 12 is a flowchart of a specific example of the monitor process when shutting down a database system; and

FIG. 13 is a diagram illustrating one example of an error output screen.

### DESCRIPTION OF EMBODIMENTS

When reading the data, the disk areas not being accessed are not error-checked. The disk areas not being accessed are set as monitoring target areas, and consequently the error-check itself causes a load when periodically performing the error-check irrespective of whether the disk area is accessed, with the result that data accessibility might decline due to the load caused when error-checking.

An embodiment of the present invention will hereinafter be described based on the drawings. A configuration of the following embodiment is an exemplification, and the present invention is not limited to the configuration of the embodiment.

### COMPARATIVE EXAMPLE

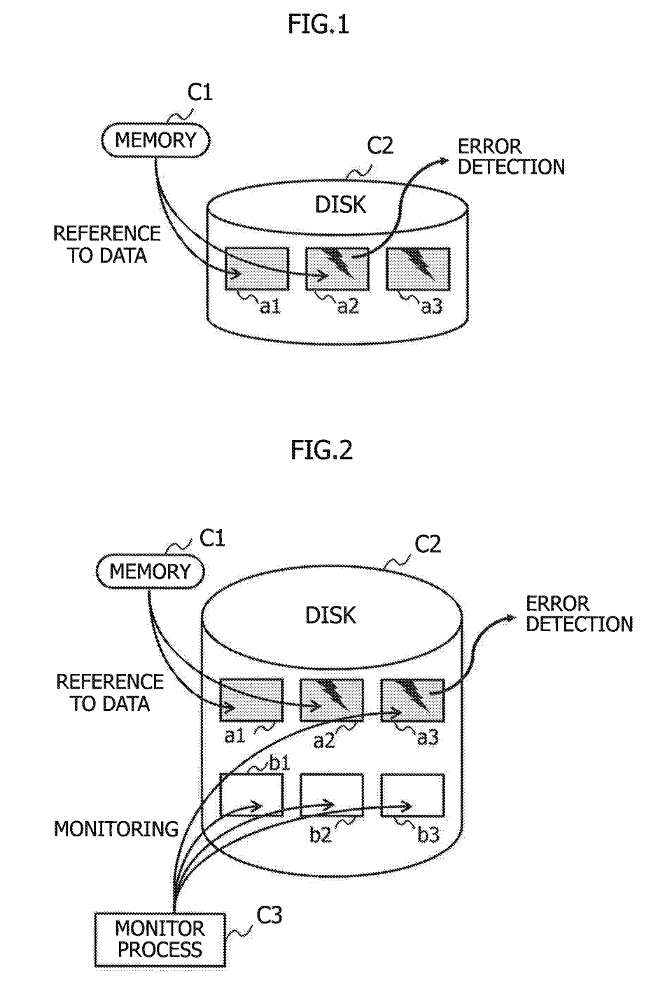

FIGS. 1 and 2 are explanatory diagrams each illustrating an example of monitoring a disk according to a comparative example. FIG. 1 is the diagram illustrating how the disk is monitored based on a checksum function.

In FIG. 1, a memory C1 refers to data in a disk C2. The disk C2 contains files a1, a2 and a3. Data of the files a2, a3 are corrupted. When the memory C1 accesses the file a1, the file al is subjected to an error check by the checksum function.

When the memory C1 accesses the file a2, the file a2 is error-checked by the checksum function. An abnormal state is detected from the file a2 because of the data being corrupted. The memory C1 does not access the file a3, and hence data corruption of the file a3 is not detected.

Thus, areas containing the data and receiving the accesses become monitoring targets. Accordingly, the areas not containing any data and the areas containing the data but not receiving the accesses do not become the monitoring targets. It is considered for setting the whole disk as the monitoring target to install empty files in the areas not containing any data, and to sequentially perform the error-checks.

FIG. 2 is a diagram illustrating an example of monitoring the whole disk by installing the empty files. In FIG. 2, the memory C1 refers to the data in the disk C2. The disk C2 contains the files a1, a2 and a3. Empty files b1, b2 and b3 are further allocated to the disk C2. Data of the files a2 and a3 are corrupted. In the same way as depicted in FIG. 2, the memory C1 accesses the files a1 and a2, with the result that the abnormal state is detected from the file a2.

On the other hand, a monitor process C3 monitors the files a3, b1, b2 and b3 by the checksum function separately from the data reference from the memory C1. The data of the file a3 is corrupted, resulting in error detection. Thus, the empty files are installed in the areas containing none of the data, and the monitor process C3 sequentially performs the error checks, thereby monitoring the whole disk.

The error checks are conducted in sequence irrespective of whether the data exist and are accessed and irrespective of significance of the data, in which case, however, a decline of access performance might be induced due to a rise in access load. Note that the access load is hereinafter also referred to as an Input/Output (I/O) load.

### Embodiment

According to an embodiment, an information processing apparatus monitors the disk while taking account of the I/O load. To be specific, the information processing apparatus carries out a monitor process when the I/O load is smaller than a predetermined threshold value. The information processing apparatus monitors the disk while taking account of a load entailed in monitoring the disk. The information processing apparatus determines the monitoring target data, based on a priority level and significance of the data.

According to the embodiment, the monitor process is executed while taking account of not a CPU (Central Processing Unit) load but the I/O load. This is because even when taking the CPU load into consideration, the access performance might decrease with the rise in I/O load. For example, an operation of an information analysis system leads to an increase in access to the data, and hence the access performance is affected by the I/O load. Consequently, it is desirable that the monitor process is executed while taking account of the I/O load.

It is also predicted that after the increase in access to the data, the I/O load decreases during a period of processing the accessed data. The data processing does not normally use up CPU resources. It may be therefore sufficient that the monitor process is executed by utilizing the remaining CPU resources in a decreased state of the I/O load. When a plurality of disks exists as data storage locations, the I/O load can be managed per disk, and the monitor process can be executed more efficiently.

<I/0 Load and Implementation of Monitoring>

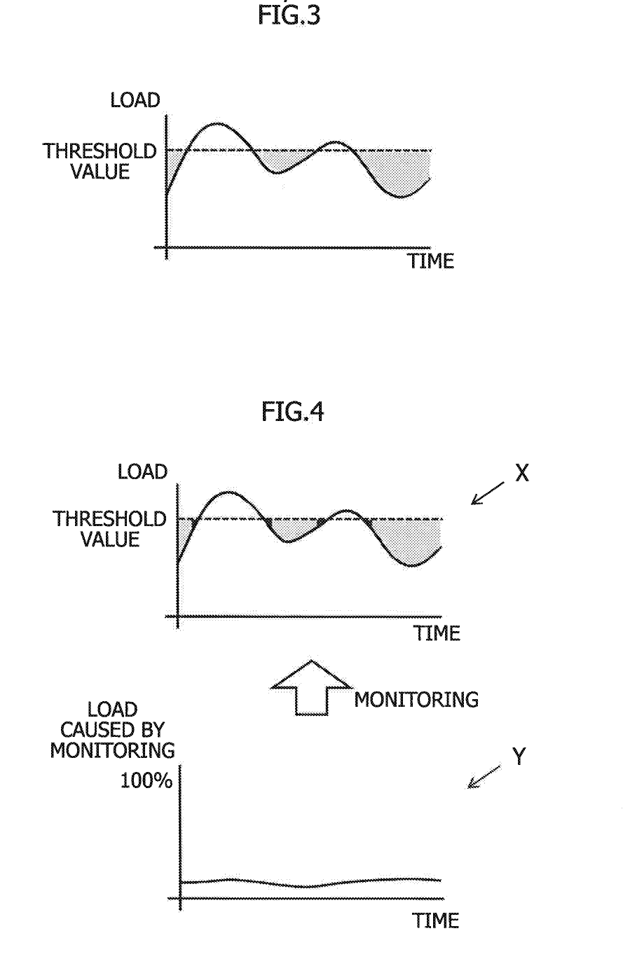

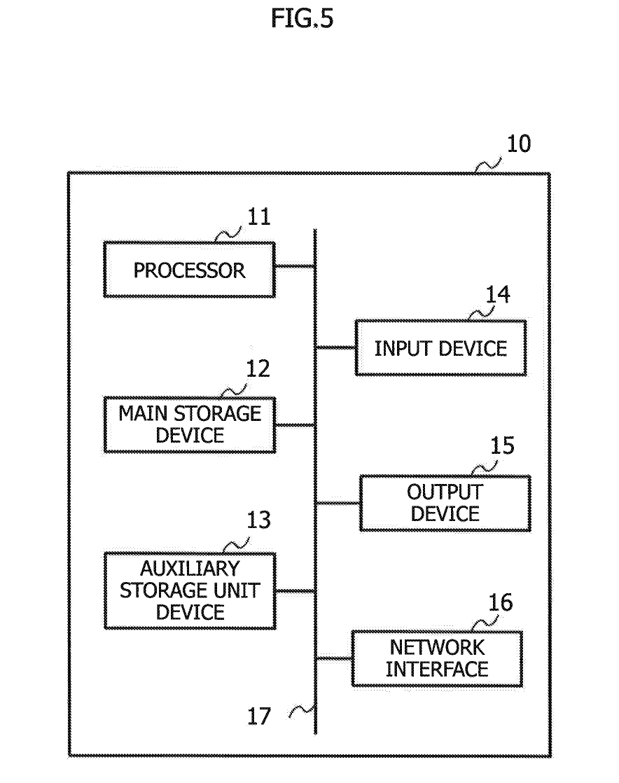

FIGS. 3 and 4 are explanatory diagrams of how the monitoring is implemented while taking account of a variation of the I/O load.

FIG. 3 is a diagram illustrating an example of the variation of the I/O load. In FIG. 3, an axis of abscissa indicates time, while an axis of ordinate indicates the I/O load. A threshold value is predefined in a range not affecting the operation. The disk monitoring is implemented when a measured I/O load is lower than the threshold value, i.e., in time zones each taking a greyish background color in FIG. 3. When the I/O load is higher than the threshold value, the disk monitoring is not implemented. Resources in the time zones having an allowance of the I/O load are thereby effectively used.

FIG. 4 is a diagram illustrating examples of the I/O load and the variation of the I/O load caused by the monitoring. Graph X in FIG. 4 illustrates, similarly to FIG. 3, the variation of the I/O load. Graph Y in FIG. 4 illustrates the example of the variation of the I/O load caused by the monitoring. When a monitoring load is added to the I/O load, an overall load exceeds the threshold value as the case may be. In FIG. 4, in areas taking the darker grayish background color before the I/O load exceeds the threshold value and after the I/O load becomes equal to or smaller than the threshold value, the overall load exceeds the threshold value, resulting in a possibility of affecting the operation. Such being the case, the disk monitoring is implemented more efficiently by making a comparison with the threshold value, including not only the I/O load but also the monitoring load.

<Hardware Configuration>

FIG. 5 is a diagram depicting one example of a hardware configuration of an information processing apparatus 10. The information processing apparatus 10 includes a processor 11, amain storage device 12, an auxiliary storage unit device 13, an input device 14, an output device 15, and a network interface 16. These components are interconnected via a bus 17.

The processor 11 loads OS and various categories of computer programs retained by the auxiliary storage device 13 onto the main storage device 12, and executes these software components, thereby carrying out a variety of processes. Part of processes of the computer programs may, however, be executed by hardware circuits. The processor 11 is exemplified by the CPU and a DSP (Digital Signal Processor).

The main storage device 12 provides the processor 11 with a storage area for loading the programs stored in the auxiliary storage device 13, and a work area for running the program. The main storage device 12 is used as a buffer for retaining data. The main storage device 12 is, e.g., a semiconductor memory instanced by a ROM (Read Only Memory) and a RAM (Random Access Memory).

The auxiliary storage device 13 stores the various categories of programs and the data used for the processor 11 to run the programs. The auxiliary storage device 13 is, e.g., a nonvolatile memory instanced by an EPROM (Erasable Programmable ROM) or an HDD (Hard Disk Drive). The auxiliary storage device 13 retains, e.g., the OS (Operating System), a control program and other various application programs. The auxiliary storage device 13 is one example of “a storage device”.

The input unit 14 accepts an operation input from the user. The input device 14 is instanced by a pointing device like a touch pad, a mouse and a touch panel, a keyboard, an operation button and a circuit to receive a signal from a remote controller. The output device 15 outputs, e.g., a result of the disk monitoring by the information processing apparatus 10. The output device 15 is, e.g., an LCD (Liquid Crystal Display).

The network interface 16 is an interface for inputting and outputting the information from and to a network. The network interface 16 connects to a wired network or a wireless network. The network interface 16 is instanced by a NIC (Network Interface Card) and a wireless LAN (Local Area Network) card. The data and other equivalent information received by the network interface 16 are output to the processor 11.

For example, the processor 11 of the information processing apparatus 10 loads the control program retained by the auxiliary storage device 13 into the main storage device 12, and runs this program. Note that the hardware configuration of the information processing apparatus 10 is one example, and the components thereof may be properly omitted, replaced or added corresponding to the embodiment without being limited to the foregoing configuration.

<Functional Configuration>

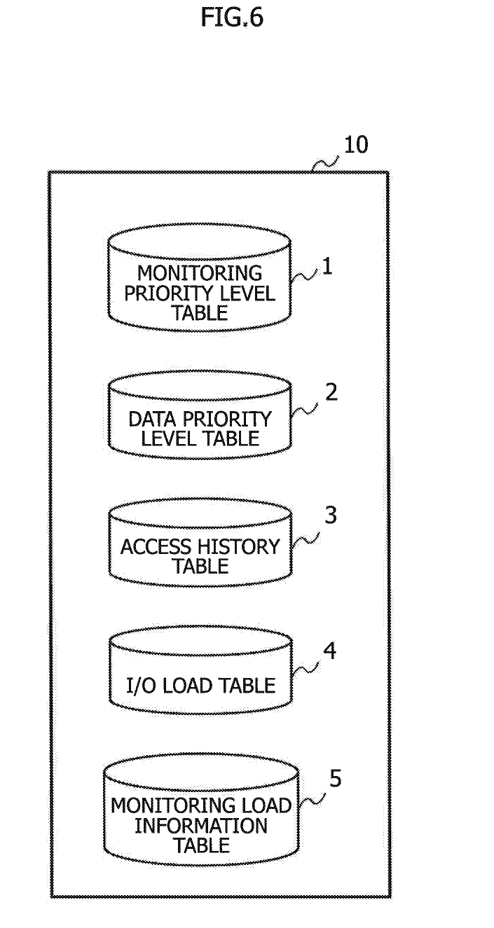

FIGS. 6 through 10 are explanatory diagrams illustrating a functional configuration of the information processing apparatus 10. FIG. 6 is the diagram illustrating one example of the functional configuration of the information processing apparatus 10. The information processing apparatus 10 includes a monitoring priority level table 1, a data priority level table 2, an access history table 3, an I/O load table 4, and a monitoring load information table 5.

The monitoring priority level table 1 is a table containing definitions of monitoring intervals per monitoring priority level. The definitions in the monitoring priority level table 1 are made by a user. The data priority level table 2 is a table for managing confidential states and the priority levels that are designated by the user per monitoring target area, e.g., per table on a database. The access history table 3 is a table for recording access time of accessing the monitoring target area.

The I/O load table 4 is a table for managing information on a current I/O load. The I/O load table 4 stores the current I/O load acquired by the processor 11 of the information processing apparatus 10. The monitoring load information table 5 is a table for managing the I/O load information generated from monitoring the disk. The I/O load caused by the monitoring can be calculated from a difference between the I/O loads before and after implementing the monitoring based on, e.g., the checksum function. The I/O load caused by the monitoring is recorded in the monitoring load information table 5 each time the monitor process is executed.

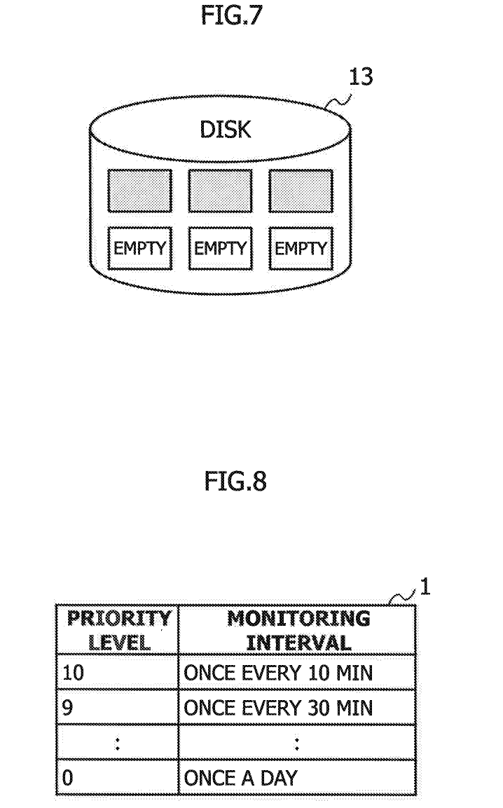

FIG. 7 is the diagram illustrating an example of the monitoring target disk. The discussion will be made based on the assumption that the monitoring target disk is the auxiliary storage device 13 in the information processing apparatus 10. The monitoring target disk 13 may, however, be an external disk connected to the information processing apparatus 10. In FIG. 7, the monitoring target disk 13 includes three files containing the data. Three empty files are allocated for setting the whole disk 13 as the monitoring target.

FIG. 8 is the diagram illustrating one example of a data structure of the monitoring priority level table 1. The monitoring priority level table 1 stores information representing the monitoring intervals per monitoring priority level. The priority level is a data priority level. The monitoring interval is a time interval for monitoring the data. The example of FIG. 8 indicates that the monitoring interval is once every ten minutes when the priority level is “10”, once every 30 minutes when the priority level is “9”, and once a day when the priority level is “0”.

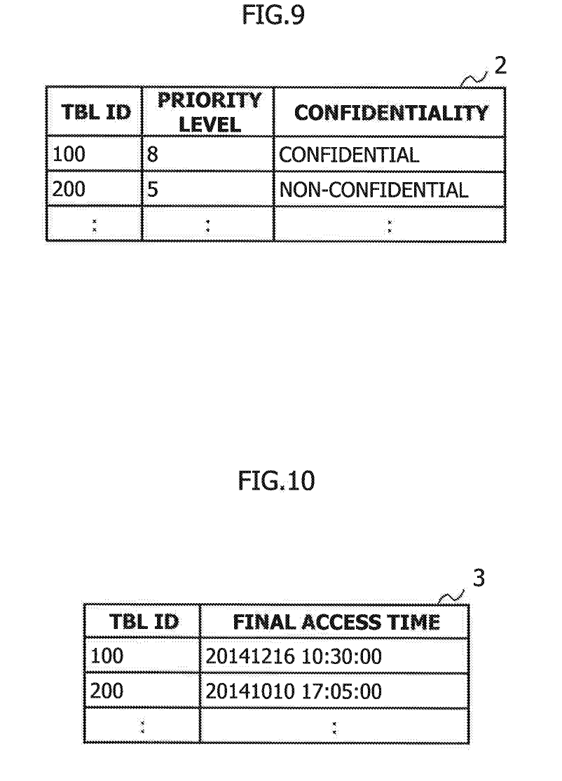

FIG. 9 is the diagram illustrating one example of the data structure of the data priority level table 2. The data priority level table 2 stores items of information representing the priority level and the confidentiality per TBL ID. The TBL ID is an ID for identifying the table on the database.

The priority level is a priority level defined in the monitoring priority level table 1. The priority level is designated based on monitor weighting by the user when generating the table. The priority level may also be designated, e.g., as an SQL (Structured Query Language)-based parameter when generating the table on the database. The data priority level table 2 is updated when generating the table.

The confidentiality is determined from whether a confidential policy is valid or invalid. The confidential policy is a definition of whether the table is set confidential or not, and is updated corresponding to a property of the data. The data priority level table 2 is updated when changing the confidential policy.

The example in FIG. 9 indicates that a table specified by TBL ID “100” has a value “8” entered in the “priority level” field and is “confidential” entered in the “confidentiality” field. It is also indicated that a table specified by TBL ID “200” has a value “5” in the “priority level” field and is “non-confidential” in the “confidentiality” field.

FIG. 10 is a diagram illustrating one example of a data structure of the access history table 3. The access history table 3 stores information representing final access time per TBL ID. The TBL ID is the ID for identifying the table on the database. The final access time is time when the table is accessed finally. The respective tables are error-checked when accessed, and hence the access history table 3 is used also as monitoring history information.

The example in FIG. 10 indicates that a table specified by TBL ID “100” is accessed finally at 10:30:00 on Dec. 16, 2014. It is also indicated that a table specified by TBL ID “200” is accessed finally at 17:05:00 on Oct. 10, 2014.

<Processing Flow>

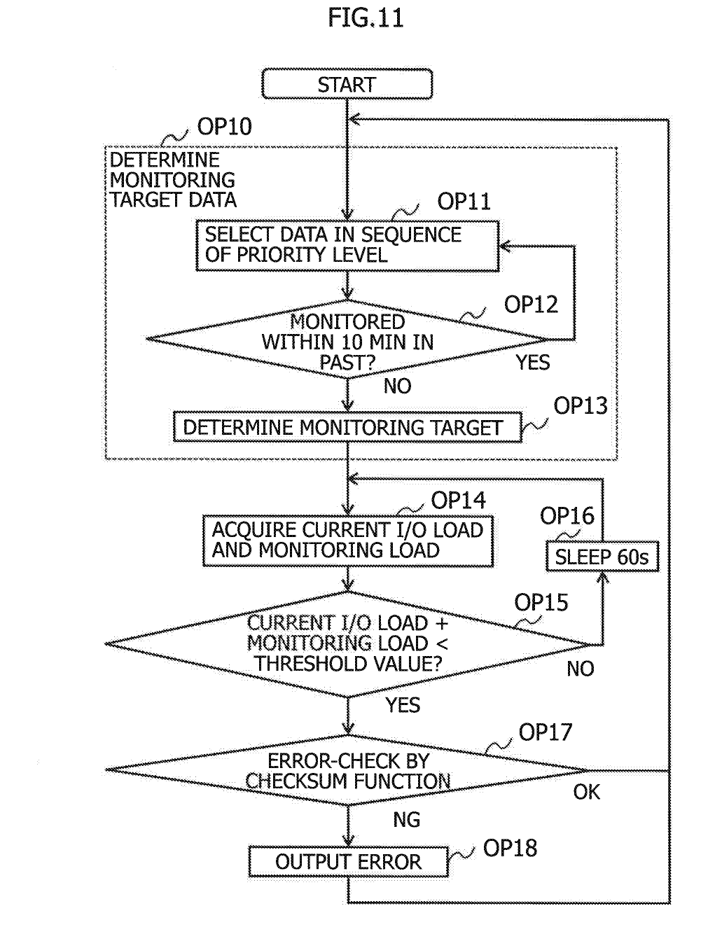

FIG. 11 is a flowchart of a specific example of the monitor process. A start of the monitor process is triggered by starting up, e.g., a database system.

In OP10, the processor 11 determines monitoring target data in a way that takes account of a data priority level and an access history. The monitoring target data is, e.g., the table on the database. In this case, the processor 11 error-checks per area storing the table in the auxiliary storage device 13. The process in OP10 is one example of a process of “determining, based on properties of data stored in respective areas in a plurality of areas within the target storage device, an target area from the plurality of areas”. The process in OP10 is exemplified by processes in OP11 through OP13.

In OP11, the processor 11 acquires the priority levels of respective items of data from the data priority level table 2, and selects the data in the sequence of the priority levels. The data priority level may be set higher as the priority level has a larger value in the data priority level table 2, and may also be set higher in the “confidential” case than in the “non-confidential” case when both of the cases have the same value of the priority level. The processing advances to OP12.

In OP12, the processor 11 refers to the access history table 3, and thus determines whether the data selected in OP11 is error-checked after a predetermined period of time ago, e.g., 10 minutes ago. In other words, it is determined whether the final access time in the access history table 3 is after 10 minutes ago. When the data is error-checked after the predetermined period of time (10 minutes) ago (OP12: YES), the processing loops back to OP11. The processor 11 selects the next data. Whereas when the data is left error-unchecked during the predetermined period of time (OP12: NO), the processing advances to OP13.

In OP13, the processor 11 determines the data being currently selected as the monitoring target data. Note that the processes in OP11 through OP13 are exemplifications, and the processor 11 may determine the monitoring target data by a variety of methods. For example, the respective items of data are rearranged corresponding to the data priority levels in OP11, in which case rearrangement keys may be set in this sequence, i.e., the priority level, the confidentiality and the monitoring interval, and may also be in another sequence, i.e., the monitoring interval, the priority level and the confidentiality.

Further, the monitoring target data may also be determined so that the monitoring is implemented at the monitoring interval defined in the monitoring priority level table 1. For instance, the data having the priority level “10” may be error-checked once every 10 minutes, and the data having the priority level “9” may be error-checked once every 30 minutes. The processing advances to OP14.

In OP14, the processor 11 acquires the current I/O load and the monitoring load. The current I/O load is acquired from the I/O load table 4. The monitoring I/O load is the I/O load applied to the monitoring, and may also take an average value of the monitoring loads recorded in the monitoring load information table 5. The monitoring load depends on a data size in the table and is not therefore constant. Accordingly, the monitoring load may also be set as the I/O load applied to the immediate past monitoring. The processing advances to OP15. The process in OP14 is one example of a process of “acquiring an access load to a target storage device”.

In OP15, the processor 11 determines whether a total of the current I/O load and the monitoring I/O load is smaller than a predetermined threshold value. When the total of the current I/O load and the monitoring I/O load is smaller than the predetermined threshold value (OP15: YES), the processing advances to OP17. Whereas when the total of the current I/O load and the monitoring I/O load is equal to or larger than the predetermined threshold value (OP15: NO), the processing diverts to OP16. In OP16, the processor 11 stands by for 60 sec and returns to OP15.

Note that with respect to OP14 and OP15, the processor 11 does not acquire the monitoring load in OP14 when not taking account of the monitoring load. In OP15, the processor 11 may simply determine whether the current I/O load is smaller than the predetermined threshold value.

In OP17, the processor 11 error-checks the selected data by, e.g., the checksum function. The error-check may be conducted, without being limited to the checksum function, by other methods instanced by CRC (Cyclic Redundancy Check) if capable of detecting the error. When the error-checked data does not contain any corruption (OP17: OK), the processor 11 updates the final access time of the error-checked table in the access history table 3. The processor 11 records the I/O load pertaining to the error check in OP17 in the monitoring load information table 5. The processing loops back to OP10.

Whereas when detecting the corruption of the error-checked data (OP17: NG), the processing advances to OP18. Note that the processes in OP15 and 17 are one examples of a process of “error-checking the target storage device when determining that the target storage device is error-checked”.

In OP18, the processor 11 outputs error information to the output device 15. The processing loops back to OP10. The monitor process illustrated in FIG. 11 is iterated till shutting down the database system.

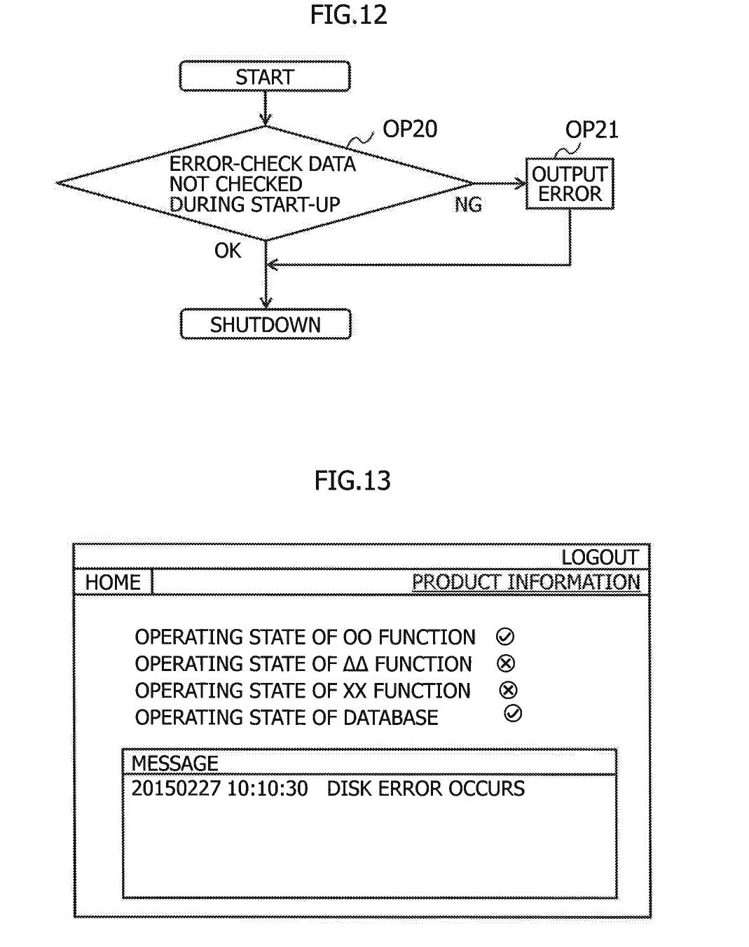

FIG. 12 is a flowchart of a specific example of the monitor process when shutting down the database system. A start of processes illustrated in FIG. 12 is triggered by, e.g., a user's instruction to shut down the database system.

In OP20, the processor 11 error-checks the data being left error-unchecked during the start-up of the database system by the checksum function. The processor 11 may determine whether the data is error-checked during the start-up, based on whether the error-check is conducted after the predetermined period of time ago by referring to, e.g., access history table 3.

When the error-checked data is not corrupted (OP20: OK), the processor 11 updates the final access time of the error-checked table in the access history table 3. The processor 11 records the I/O load pertaining to the error-check in OP20 in the monitoring load information table 5. The processing is finished, resulting in the shutdown of the database system.

Whereas when detecting the corruption of the error-checked data (OP20: NG), the processing diverts to OP21. In OP21, the processor 11 outputs the error information to the output device 15. The processing is finished, resulting in the shutdown of the database system.

FIG. 13 is a diagram illustrating one example of an error output screen. The error output screen is displayed on the output device 15, e.g., when the data corruption is detected by the error-check. In the example of FIG. 13, the error output screen displays an operating state of the database system and operating states of the respective functions of the database system. A message saying, e.g., “Disk Error occurs at 20150227 10:10:30” is displayed in a message window on the error output screen.

As one of other items of error information, the information about the table with the occurrence of error may also be output. A setting of restricting the access may be done in the table with the occurrence of error. The user can cope with the data corruption, based on the error information displayed on the error output screen.

### Operational Effect of Embodiment

According to the embodiment, the information processing apparatus 10 acquires the current I/O load, implements the disk monitoring when the I/O load is equal to or smaller than the threshold value, and error-checks the monitoring target data. The disk monitoring is implemented when the I/O load has the allowance, thereby leveling the loads. The information processing apparatus 10 can implement the disk monitoring without affecting the operation even during the running of the database system. In other words, the information processing apparatus 10 can restrain the data access performance from decreasing due to the disk monitoring.

When an architecture of the database system is known beforehand, the disk can be monitored without using an external monitor tool, thereby reducing costs for introducing and operating the monitor tool. A system administrator does not perform the operation of monitoring the disk, and the user can therefore easily introduce the information processing apparatus 10 by defining the data priority levels.

The disk monitoring also causes the I/O load, and the load caused by the disk monitoring varies depending on the data size. The information processing apparatus 10 can restrain the overall I/O load from exceeding the threshold value by taking account of the load caused by the disk monitoring in addition to the current I/O load. The information processing apparatus 10 is thereby enabled to restrain the data access performance from decreasing without being affected by the variation in load caused by the disk monitoring.

The information processing apparatus 10 determines the error-check target data, based on the priority level and the significance of the data. The data exhibiting the higher priority level or significance than other data is preferentially error-checked, whereby the disk monitoring can be efficiently implemented.

The information processing apparatus 10 outputs the error information when detecting the data corruption. When the data is corrupted, a variety risks might occur. For example, such risks are considered that the operation is stopped, adding/deleting operations for the corrupted data are not executed, and an influence range expands due to the access to the corrupted data.

The information processing apparatus 10 can notify the user of a possibility of stopping the operation by outputting the error information. The user performs countermeasures instanced by saving other data and recovering the corrupted area, and is thereby enabled to prevent the occurrence of the risks due to the data corruption beforehand.

According to one aspect, the data access performance can be restrained from decreasing due to the error-check.

<Non-Transitory Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM and other equivalent recording mediums are given as the non-transitory recording mediums fixed within the computer and other equivalent apparatuses. Further, a solid state drive (SSD) is also available as the non-transitory recording medium removable from the computer and other equivalent apparatuses and also as the non-transitory recording medium fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process comprising:
acquiring an access load to a target storage device;
determining, based on the access load and a monitoring load with respect to the target storage device, whether the target storage device is error-checked or not; and
error-checking the target storage device when determining that the target storage device is error-checked.

2. The computer-readable recording medium according to claim 1, wherein the process further comprises determining, based on properties of data stored in respective areas in a plurality of areas within the target storage device, an target area from the plurality of areas, and error-checking the target area.

3. The computer-readable recording medium according to claim 1, wherein the target storage device is used for a predetermined database system, and the process further comprises error-checking, by a shutdown of the predetermined database system in response to an instruction to shut down the predetermined database system, areas of the target storage device, the areas being left error-unchecked during an operation of the predetermined database system.

4. An information processing apparatus comprising:
a target storage device; and
a processor configured to acquire an access load to the target storage device;
to determine, based on the access load and a monitoring load with respect to the target storage device, whether the target storage device is error-checked or not; and
to error-check the target storage device when determining that the target storage device is error-checked.

5. A control method comprising:
acquiring, by a processor of a computer, an access load to a target storage device;
determining, based on the access load and a monitoring load with respect to the target storage device, whether the target storage device is error-checked or not; and
error-checking, by the processor, the target storage device when determining that the target storage device is error-checked.
